(19) United States
(12) Patent Application Publication
(10) Pub. No.: US 2024/0145678 A1
(43) Pub. Date: May 2, 2024

(54) HOMOGENEOUS SILICON CARBIDE MATERIAL, ELECTRODE PLATE, AND BATTERY

(71) Applicant: ZHUHAI COSMX BATTERY CO., LTD., Zhuhai (CN)

(72) Inventors: Jiachen XUE, Zhuhai (CN); Hui WANG, Zhuhai (CN); Suli LI, Zhuhai (CN); Chunyang LIU, Zhuhai (CN)

(73) Assignee: ZHUHAI COSMX BATTERY CO., LTD., Zhuhai (CN)

(21) Appl. No.: 18/512,427

(22) Filed: Nov. 17, 2023

Related U.S. Application Data
(63) Continuation-in-part of application No. PCT/CN2022/131902, filed on Nov. 15, 2022.

(30) Foreign Application Priority Data
Nov. 29, 2021 (CN) 202111435889.2
Nov. 18, 2022 (CN) 202211449297.0
Nov. 18, 2022 (CN) 202211449298.5

(51) Int. Cl. H01M 4/36; H01M 4/02; H01M 4/04; H01M 4/38; H01M 4/583

(52) U.S. Cl. CPC H01M 4/364; H01M 4/0404; H01M 4/366; H01M 4/386; H01M 4/583; H01M 2004/021; H01M 2004/027

(57) ABSTRACT

Disclosed are a homogeneous silicon carbide material and an electrode plate and a battery that include the homogeneous silicon carbide material. A negative electrode plate in the battery of the present disclosure includes a homogeneous silicon carbide material. The homogeneous silicon carbide material includes an element Si and an element C. The homogeneous silicon carbide material is a homogeneous material and has a bi-continuous phase structure. The homogeneous silicon carbide material in the present disclosure has better cycling performance and higher specific capacity.

### CROSS-REFERENCE TO RELATED APPLICATIONS

The present disclosure is a continuation-in-part of International Application No. PCT/CN2022/131902, filed on Nov. 15, 2022, which claims priority to Chinese Patent Application No. CN202111435889.2, filed on Nov. 29, 2021. The present disclosure also claims priority to Chinese Patent Application No. CN202211449297.0, filed on Nov. 18, 2022, and Chinese Patent Application No. CN202211449298.5, filed on Nov. 18, 2022. All of the aforementioned patent applications are hereby incorporated by reference in their entireties.

### TECHNICAL FIELD

The present disclosure relates to the field of battery technologies, and more specifically, to a homogeneous silicon carbide material, and an electrode plate and a battery that include the homogeneous silicon carbide material.

### BACKGROUND

Conventional lithium cobalt oxide (LCO), lithium iron phosphate (LFP), nickel-cobalt-manganese (NCM), and nickel-cobalt-aluminum (NCA) positive electrode materials in combination with a graphite negative electrode material cannot meet an increasing energy density requirement in the market. Therefore, it is necessary to develop a positive and negative electrode system with new high energy density.

Silicon-based negative electrode materials have good performance such as high specific capacity, low cost, and easy processing. A silicon oxide (SiOₓ, 1.2>x>0.8) material has a relatively low specific capacity (less than 1800 mAh/g), but has a long cycle life, which meets a requirement of a pouch battery for a negative electrode material, and is increasingly favored by pouch battery manufacturers. Although more and more manufacturers shift their research focus to the SiOₓ material, continuous volume expansion during cycling remains a main obstacle that restricts large-scale application of the SiOₓ material.

Because a lithium intercalation mechanism of a silicon-based negative electrode material is different from that of an anisotropic graphite-based negative electrode material, an alloying process of the silicon-based negative electrode material is accompanied by a very large isotropic expansion. In actual use, an expanded SiOₓ material generates a relatively large expansion in an electrode plate plane, causing an increase in internal stress of the negative electrode plate, resulting in distortion and deformation of the negative electrode plate and even tear of substrate copper foil, or a more serious safety problem caused by battery cell failure.

Si and SiC type negative electrode materials have advantages of high specific capacity (about 3400 mAh/g) and long cycle life. Si composite doped graphite negative electrode has been widely used in the field of high energy density cylinders and steel shell power batteries. But Si and SiC type negative electrode materials may face many difficulties in the practical application of pouch batteries because of the problems of large volume expansion, detachment of an effective active material from a conductive network due to easy particle detachment, and accelerated consumption of electrolyte solution and increased internal resistance caused by repeated generation and destruction of SEI film due to particle fragmentation in a cycling process. However, considering the Si and SiC type negative electrode materials have higher specific capacity, longer cycle and higher initial coulomb efficiency, the application of the SiC negative electrode material will have more possibility and wider prospect.

Therefore, it is urgent to develop a battery with good cycling stability, low expansion rate, and long service life.

### SUMMARY

The inventors of the present disclosure found through research that, conventional SiC materials are secondary large particles composed of carbon composite with individual silicon nanoparticles, and there is obvious phase separation between silicon and carbon in the material, that is, there is still a distinct boundary between the two components at a microstructural level. This structure hampers cycling stability of the SiC materials, and may cause problems such as thickening of an SEI film and accelerated attenuation of capacity.

The objective of the present disclosure is to overcome the problems in a conventional technology by providing a homogeneous silicon carbide material and an electrode plate and a battery that include the homogeneous silicon carbide material. The homogeneous silicon carbide material in the present disclosure is a homogeneous material and has a bi-continuous phase structure, thus having better cycling stability and a high specific capacity. The electrode plate in the present disclosure has better cycling stability and lower expansion rate. The battery including the electrode plate in the present disclosure has higher cycling stability, lower expansion rate, and longer service life.

To achieve the foregoing objective, according to a first aspect of the present disclosure, a homogeneous silicon carbide material is provided. The homogeneous silicon carbide material includes an element Si and an element C, and the homogeneous silicon carbide material is a homogeneous material and has a bi-continuous phase structure.

According to a second aspect of the present disclosure, an electrode plate is provided. The electrode plate includes a negative electrode current collector and a negative electrode active material layer coated on at least one side surface of the negative electrode current collector, the negative electrode active material layer includes a negative electrode active material, and the negative electrode active material includes the homogeneous silicon carbide material according to the first aspect of the present disclosure and graphite.

According to a third aspect of the present disclosure, a battery is provided, and the battery includes the electrode plate according to the second aspect of the present disclosure.

Based on the foregoing technical solutions, the present disclosure has at least the following advantages over the conventional technology.

The negative electrode active material in the negative electrode plate of the battery in the present disclosure includes a homogeneous silicon carbide material. Compared with a conventional SiC material, the homogeneous silicon carbide material in the present disclosure has better cycling performance and a high specific capacity, so that electrolyte solution consumption, side reaction, and expansion during cycling can be reduced, and problems such as low initial Coulombic efficiency, rapid capacity attenuation and high expansion during cycling in a high-ratio composite negative electrode may be effectively solved, thereby significantly improving energy density and a cyclic life of the battery. Thus, the homogeneous silicon carbide material is suitable for large-scale commercial production.

In summary, the energy density of the battery in the present disclosure is significantly improved, and problems of rapid attenuation and high expansion during cycling can be effectively solved, so that the battery has a longer service life.

### BRIEF DESCRIPTION OF THE DRAWINGS

FIG. 1 is an X-ray diffraction (XRD) pattern of a homogeneous silicon carbide material in Example I-1 of the present disclosure.

FIG. 2 is a scanning electron microscopy (SEM) cross-sectional view of a homogeneous silicon carbide material according to Example I-1 of the present disclosure, where an internal structure of particles is a homogeneous structure at 50K magnification.

FIG. 3 is an SEM cross-sectional view of a material LiSi—C according to Example II-1 of the present disclosure, where an internal structure of particles is a homogeneous structure at 50K magnification.

FIG. 4 is an XRD pattern of a material LiSi—C according to Example II-1 of the present disclosure.

FIG. 5 is a TEM diagram of a coated material LiSi—C according to Example III-1 of the present disclosure.

FIG. 6 is a schematic structural diagram of a coated material LiSi—C of the present disclosure.

FIG. 7 is a diagram of an SEM cross-sectional view of a coated material LiSi—C according to Example III-1 of the present disclosure, where an internal structure of particles is a homogeneous structure at 50K magnification.

FIG. 8 is an XRD pattern of a coated material LiSi—C according to Example III-1 of the present disclosure.

FIG. 9 shows a negative electrode slurry prepared from a material obtained in Example III-1 of the present disclosure.

FIG. 10 shows a negative electrode slurry prepared from a material obtained in Example III-2 of the present disclosure.

FIG. 11 shows a negative electrode slurry prepared from a material obtained in Comparative Example III-1 of the present disclosure.

FIG. 12 shows a negative electrode slurry prepared from a material obtained in Comparative Example III-2 of the present disclosure.

FIG. 13 is an SEM cross-sectional view of a conventional material SiC in Comparative Example I-1 or Comparative Example II-1 or Comparative Example II-3 (they are the same comparative example with different numbers), with internal Si/C phases at 50K magnification (light color represents a Si phase component, and dark color represents a carbon phase component).

### DETAILED DESCRIPTIONS OF THE EMBODIMENTS

Specific implementations of the present disclosure are described below in detail. It should be understood that the specific implementations described herein are merely used for the purposes of illustrating and explaining the present disclosure, rather than limiting the present disclosure.

Homogeneous Silicon Carbide Material

According to a first aspect of the present disclosure, a homogeneous silicon carbide material is provided. The homogeneous silicon carbide material includes an element Si and an element C, and the homogeneous silicon carbide material is a homogeneous material and has a bi-continuous phase structure.

In the present disclosure, the bi-continuous phase means that a phase formed by the element Si and a phase formed by the element C in the homogeneous silicon carbide material are continuous, and there is no distinct boundary between the two phases at a microstructural level. Different from a conventional SiC-type negative electrode material, the homogeneous silicon carbide material described in the present disclosure is a silicon carbide material formed by an element Si and an element C and having a bi-continuous phase structure, and there is no phase separation between silicon and carbon in structure, that is, there is no distinct boundary between the two components at a microstructural level. On the contrary, the element Si and the element C may form a continuous phase structure, and such structure is conducive to improving cycling stability of a battery.

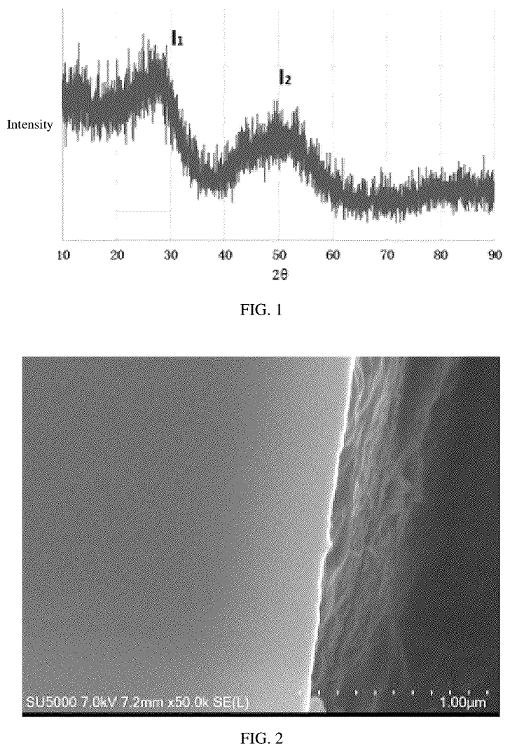

In an example, in an X-ray diffraction pattern of the homogeneous silicon carbide material, a maximum intensity of a broad peak occurs when 2θ is in a range from 20° to 40° is I₁, and a maximum intensity of a broad peak occurs when 2θ is in a range from 40° to 60° is I₂, where I₁>I₂, for example, as shown in FIG. 1.

In an example, in a region that is inside the homogeneous silicon carbide material and 100 nm away from a surface of the homogeneous silicon carbide material, mass proportions C_{A} and C_{B} of the element C at any two positions A and B satisfy: |C_{A}−C_{B}|≤15% (for example, 1%, 3%, 5%, 7%, 10%, 12%, or 15%), and preferably, |C_{A}−C_{B}|≤10%.

In an example, a specific surface area of a phase formed by the element C in the homogeneous silicon carbide material ranges from 900 m²/g to 1500 m²/g, for example, 900 m²/g, 1000 m²/g, 1100 m²/g, 1200 m²/g, 1300 m²/g, 1400 m²/g, or 1500 m²/g. Preferably, the specific surface area ranges from 1000 m²/g to 1400 m²/g.

In an example, a mass percentage of the element C in the homogeneous silicon carbide material ranges from 30 wt % to 70 wt %, for example, 30 wt %, 35 wt %, 40 wt %, 45 wt %, 50 wt %, 55 wt %, 60 wt %, 65 wt %, or 70 wt %. Preferably, a mass percentage of the element C ranges from 40 wt % to 60 wt %.

In an example, a porosity of a phase formed by the element C in the homogeneous silicon carbide material ranges from 0.4 cc/g to 1.1 cc/g, for example, 0.4 cc/g, 0.5 cc/g, 0.6 cc/g, 0.7 cc/g, 0.8 cc/g, 0.9 cc/g, 1 cc/g, or 1.1 cc/g. Preferably, the porosity ranges from 0.6 cc/g to 0.9 cc/g.

In an example, a phase formed by the element C in the homogeneous silicon carbide material is a porous structure.

In an example, the porous structure is a mixed structure of a mesopore and a micropore. For example, a pore diameter of the mesopore is concentrated in a range from 4 nm to 14 nm. For another example, the pore diameter of the mesopore is concentrated in a range from 6 nm to 12 nm. For example, a pore diameter of the micropore pore is concentrated in a range less than or equal to 1 nm.

In an example, a micropore porosity of a phase formed by the element C in the homogeneous silicon carbide material ranges from 0.3 cc/g to 0.9 cc/g, for example, 0.3 cc/g, 0.4 cc/g, 0.5 cc/g, 0.6 cc/g, 0.7 cc/g, 0.8 cc/g, or 0.9 cc/g. Preferably, the microporous porosity ranges from 0.4 cc/g to 0.6 cc/g.

In an example, a mesopore porosity of a phase formed by the element C in the homogeneous silicon carbide material ranges from 0.1 cc/g to 0.4 cc/g, for example, 0.1 cc/g, 0.15 cc/g, 0.2 cc/g, 0.25 cc/g, 0.3 cc/g, 0.35 cc/g, or 0.4 cc/g. Preferably, the mesoporous porosity ranges from 0.15 cc/g to 0.35 cc/g.

In an example, a median particle size Dᵥ₅₀ of the homogeneous silicon carbide material ranges from 5 μm to 15 μm, for example, 5 μm, 6 μm, 7 μm, 8 μm, 9 μm, 10 μm, 11 μm, 12 μm, 13 μm, 14 μm, or 15 μm.

In an example, a specific surface area of the homogeneous silicon carbide material ranges from 3 m²/g to 10 m²/g, for example, 3 m²/g, 4 m²/g, 5 m²/g, 6 m²/g, 7 m²/g, 8 m²/g, 9 m²/g, or 10 m²/g.

In the present disclosure, the homogeneous silicon carbide material is a homogeneous SiC material.

Preparation Method for Homogeneous Silicon Carbide

In an example, the homogeneous silicon carbide material may be obtained by commercial purchase or may be prepared according to the following method:
continuously introducing silane gas into a porous carbon material for a specific period of time at vacuum and a temperature ranging from 350° C. to 450° C. (for example, at 350° C., 380° C., 400° C., 420° C., or 450° C.); and raising the temperature to a range from 550° C. to 750° C. (for example, at 550° C., 600° C., 650° C., 700° C., or 750° C.) and then introducing a carbon source gas for a specific period of time, and cooling the material to room temperature under protection of an inert gas to obtain the homogeneous SiC material.

The silane gas is, for example, SiH₄.

The period of time for introducing the silane gas ranges from 12 hours to 24 hours, for example, 12 hours, 15 hours, 20 hours, or 24 hours. The carbon source gas is at least one of ethylene or acetylene.

The period of time for introducing the carbon source gas ranges from 20 minutes to 60 minutes, for example, 20 minutes, 25 minutes, 30 minutes, 35 minutes, 40 minutes, 45 minutes, 50 minutes, 55 minutes, or 60 minutes.

The inert atmosphere is, for example, argon.

Material LiSi—C

In an example, an element Li is introduced into the homogeneous silicon carbide material to form a material LiSi—C, and the material LiSi—C has a continuous phase structure in which a LiSi phase and a C phase are uniformly doped. Characteristic peaks exist in an X-ray diffraction pattern of the material LiSi—C, and the characteristic peaks occur when 2θ is in a range from 23° to 24° and is in a range from 41° to 42°.

The inventors of the present disclosure found through further research that, to improve the initial efficiency for the full battery and the stability in an aqueous slurry during actual use of the homogeneous silicon carbide material, a structure of a SiC material in a negative electrode active material may be changed, so that a structure of the SiC material helps improve cycling performance and reducing expansion performance of an electrode plate. The inventors of the present disclosure found through a great deal of in-depth research that, when an element Li is introduced into a silicon carbide material, a material LiSi—C having a bi-continuous phase structure is formed, and the structure helps improve cycling stability of the electrode plate and reduce expansion performance of the electrode plate.

Compared with that in a conventional technology, in the present disclosure, adding the element Li to a silicon carbide material can make the material LiSi—C have better cycling stability.

The material LiSi—C may be a lithium silicon carbide material.

The material LiSi—C may have a continuous phase structure in which a LiSi phase and a C phase are uniformly doped. The continuous phase structure indicates that the LiSi phase and the C phase are continuous, and there is no distinct boundary between the two phases at a microstructural level.

For example, an SEM cross-sectional view of the material LiSi—C is shown in FIG. 3 with an internal structure of particles at 50K magnification. It may be learned that, at 50K magnification, the internal structure of particles of the material LiSi—C is uniform, and there is no distinct boundary between the two phases.

Characteristic peaks may present in an X-ray diffraction pattern of the material LiSi—C, and the characteristic peaks occur when 2θ is in a range from 23° to 24° and is in a range from 41° to 42°.

The characteristic peaks represent existence of Li. When the characteristic peaks exist in an X-ray diffraction pattern of the material LiSi—C when 2θ is in a range from 23° to 24° and is in a range from 41° to 42°, it indicates that Li exists in the material LiSi—C.

There may be two characteristic peaks in the X-ray diffraction pattern of the material LiSi—C, one occurs when 2θ is in a range from 23° to 24° and the other occurs when 2θ is in a range from 41° to 42°

According to a preferred specific implementation, in the X-ray diffraction pattern of the material LiSi—C, a maximum intensity of the characteristic peak occurs when 2θ is in a range from 23° to 24° is I₃, and a maximum intensity of the characteristic peak occurs when 2θ is in a range from 41° to 42° is I₄, where I₃>I₄.

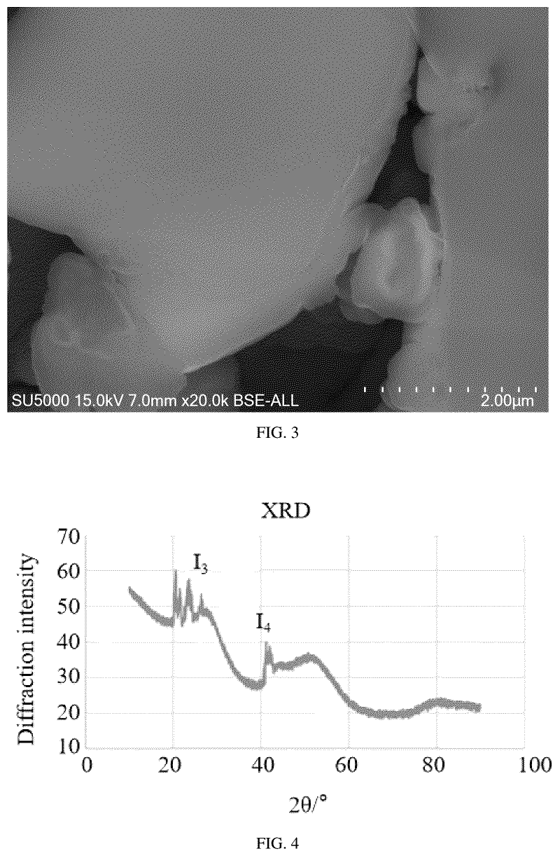

For example, an X-ray diffraction pattern of the material LiSi—C is shown in FIG. 4, where I₃ is the maximum intensity of the characteristic peak occurred when 2θ is in a range from 23° to 24° and I₄ is the maximum intensity of the characteristic peak occurred when 2θ is in a range from 41° to 42°.

In an example, in a region that is inside the material LiSi—C and 100 nm away from a surface of the material LiSi—C, mass proportions of the element C at any two positions A and B are C_{A} and C_{B} that satisfy: |C_{A}−C_{B}|≤15% (for example, 1%, 3%, 5%, 7%, 10%, 12%, or 15%).

The expression |C_{A}−C_{B}|≤15% indicates that an internal structure of the material LiSi—C is uniform, and the element C is evenly distributed at any position in the material LiSi—C.

According to a preferred specific implementation, in a region that is inside the material LiSi—C and 100 nm away from a surface of the material LiSi—C, mass proportions of the element C at any two positions A and B are C_{A} and C_{B} that satisfy: |C_{A}−C_{B}|≤10%.

In an example, in an SEM cross-sectional view of the material LiSi—C, an internal structure of particles is a homogeneous structure at 50K magnification. The homogeneous structure represents that the internal structure of particles is uniform, and there is no separation between a silicon phase and a carbon phase.

In an example, a porosity of a C phase in the material LiSi—C ranges from 0.4 cc/g to 1.1 cc/g (for example, 0.4 cc/g, 0.5 cc/g, 0.6 cc/g, 0.7 cc/g, 0.8 cc/g, 0.9 cc/g, 1 cc/g, or 1.1 cc/g).

In an example, the porosity of the C phase in the material LiSi—C ranges from 0.6 cc/g to 0.9 cc/g.

In the present disclosure, the term “porosity of a C phase” does not have a same meaning as a common porosity. In the material LiSi—C disclosed in the present disclosure, the C phase is uniformly distributed, and therefore the “porosity of a C phase” is used to express distribution of the C phase in the material LiSi—C. A porosity of a remaining C-phase skeleton may be measured in a manner of etching out Li and Si in the material LiSi—C(that is, a porosity does not exist between C phases in the material LiSi—C), to represent the porosity of the C phase in the material LiSi—C.

In an example, a specific surface area of the C phase in the material LiSi—C ranges from 700 m²/g to 1500 m²/g (for example, 700 m²/g, 900 m²/g, 1000 m²/g, 1200 m²/g, or 1500 m²/g).

In an example, the specific surface area of the C phase in the material LiSi—C ranges from 1000 m²/g to 1400 m²/g.

In the present disclosure, the term “specific surface area of the C phase” does not have a same meaning as a common specific surface area. In the material LiSi—C disclosed in the present disclosure, the C phase is uniformly dispersed, and therefore the “specific surface area of the C phase” is used to express a status of a C-phase skeleton in the material LiSi—C. A specific surface area of a remaining C-phase skeleton may be measured in a manner of etching out Li and Si in the material LiSi—C (that is, a porosity does not exist between C phases in the material LiSi—C), to represent the specific surface area of the C phase in the material LiSi—C.

Based on the remaining C-phase skeleton structure after the LiSi phase is dissolved, a porous structure of the C phase is a mixed structure of a mesopore and a micropore.

In an example, a pore diameter of the mesopore is concentrated in a range from 4 nm to 14 nm (for example, 4 nm, 5 nm, 8 nm, 10 nm, 12 nm, or 14 nm).

In an example, the pore diameter of the mesopore is concentrated in a range from 6 nm to 12 nm.

In an example, a pore diameter of the micropore pore is concentrated in a range less than or equal to 1 nm.

In an example, a mesopore porosity of the C phase in the material LiSi—C ranges from 0.1 cc/g to 0.4 cc/g (for example, 0.1 cc/g, 0.15 cc/g, 0.2 cc/g, 0.25 cc/g, 0.3 cc/g, 0.35 cc/g, or 0.4 cc/g).

In an example, the mesoporous porosity of the C phase in the material LiSi—C ranges from 0.15 cc/g to 0.35 cc/g.

In an example, a micropore porosity of the C phase in the material LiSi—C ranges from 0.3 cc/g to 0.9 cc/g (for example, 0.3 cc/g, 0.4 cc/g, 0.5 cc/g, 0.6 cc/g, 0.7 cc/g, 0.8 cc/g, or 0.9 cc/g).

In an example, the micropore porosity of the C phase in the material LiSi—C ranges from 0.4 cc/g to 0.6 cc/g.

According to a specific implementation, using a total weight of the material LiSi—C as a reference, in the material LiSi—C, a content of the element C ranges from 30 wt % to 70 wt % (for example, 30 wt %, 35 wt %, 40 wt %, 45 wt %, 50 wt %, 55 wt %, 60 wt %, 65 wt %, or 70 wt %), a content of the element Li ranges from 0.2 wt % to 5 wt % (for example, 0.2 wt %, 0.5 wt %, 1 wt %, 1.5 wt %, 2 wt %, 2.5 wt %, 3 wt %, 3.5 wt %, 4 wt %, 4.5 wt %, or 5 wt %), and a content of the element Si ranges from 29.8 wt % to 65 wt % (for example, 29.8 wt %, 30 wt %, 35 wt %, 40 wt %, 45 wt %, 50 wt %, 60 wt %, or 65 wt %).

According to a preferred specific implementation, using a total weight of the material LiSi—C as a reference, a content of the element C in the material LiSi—C ranges from 40 wt % to 60 Wt %.

In an example, the material LiSi—C is in a form of particles, and a median particle size Dᵥ₅₀ ranges from 5 μm to 15 μm (for example, 5 μm, 6 μm, 7 μm, 8 μm, 9 μm, 10 μm, 11 μm, 12 μm, 13 μm, 14 μm, or 15 μm). In the present disclosure, the median particle size Dᵥ₅₀ may be obtained by means of a laser particle size analyzer.

According to a specific implementation, the material LiSi—C has a porous structure.

In an example, a specific surface area of the material LiSi—C ranges from 3 m²/g to 10 m²/g (for example, 3 m²/g, 4 m²/g, 5 m²/g, 6 m²/g, 7 m²/g, 8 m²/g, 9 m²/g, or 10 m²/g).

Preparation Method for a Material LiSi—C

The present disclosure provides a method for preparing a material LiSi—C. A porous carbon material is in a first contact with a lithium source under protection of an inert gas, then the material is in a second contact with a silicon source gas or a mixture of a silicon source gas and a first carbon source gas, and then the material is in a third contact with a second carbon source gas.

In an example, the lithium source is a lithium vapor.

According to a specific implementation, conditions of the first contact may include a temperature ranging from 250° C. to 450° C. (for example, 250° C., 270° C., 300° C., 320° C., 350° C., 370° C., 400° C., 420° C., or 450° C.), a period of time ranging from 5 minutes to 60 minutes (for example, 5 minutes, 10 minutes, 15 minutes, 20 minutes, 25 minutes, 30 minutes, 35 minutes, 40 minutes, 45 minutes, 50 minutes, 55 minutes, or 60 minutes), and a vacuum ranging from 10⁻³ Pa to 10 Pa (for example, 10⁻³ Pa, 1×10⁻² Pa, 5×10⁻² Pa, 0.1 Pa, 0.5 Pa, 1 Pa, 3 Pa, 5 Pa, 7 Pa, or 10 Pa).

In an example, the silicon source gas is SiH₄.

In an example, the first carbon source gas is selected from one or more of ethane, ethylene, or acetylene.

According to a specific implementation, conditions of the second contact may include a temperature ranging from 400° C. to 550° C. (for example, 400° C., 420° C., 450° C., 470° C., 500° C., 520° C., or 550° C.), and a period of time ranging from 6 hours to 24 hours (for example, 6 hours, 10 hours, 15 hours, 20 hours, or 24 hours).

In an example, the second carbon source is selected from one or more of ethane, ethylene, or acetylene.

According to a specific implementation, conditions of the third contact may include a temperature ranging from 500° C. to 650° C. (for example, 500° C., 520° C., 550° C., 570° C., 600° C., 620° C., or 650° C.) and a period of time ranging from 20 minutes to 60 minutes (for example, 20 minutes, 25 minutes, 30 minutes, 35 minutes, 40 minutes, 45 minutes, 50 minutes, 55 minutes, or 60 minutes).

According to a specific implementation, after the third contact, the material is cooled to room temperature under protection of an inert gas.

In an example, the inert gas may be argon.

Coated material LiSi—C

In an example, a coated material LiSi—C with a core-shell structure is formed by using the material LiSi—C as a core.

The material LiSi—C has a continuous phase structure in which a LiSi phase and a C phase are uniformly doped. Characteristic peaks exist in an X-ray diffraction pattern of the material LiSi—C, and the characteristic peaks occur when 2θ is in a range from 23° to 24° and is in a range from 41° to 42°. A shell of the coated material LiSi—C is an oxygen-containing coating layer.

The inventors of the present disclosure find that an element Li is introduced into a silicon carbide material, to make the material have a bi-continuous phase homogeneous structure. Then, a coated material LiSi—C having an oxygen-containing coating layer is formed by performing oxygen-containing coating modification processing. The bi-continuous phase structure helps to improve cycling stability of an electrode plate and reduce expansion performance of the electrode plate. A shell of the oxygen-containing coating layer can help to effectively improve stability of the oxygen-containing coating layer in an aqueous slurry, to solve a problem of gas generation due to reaction of a homogeneous material Li—SiC with water, and also reduce a side reaction between a negative electrode active material and an electrolyte solution, thereby improving cycling performance of a battery.

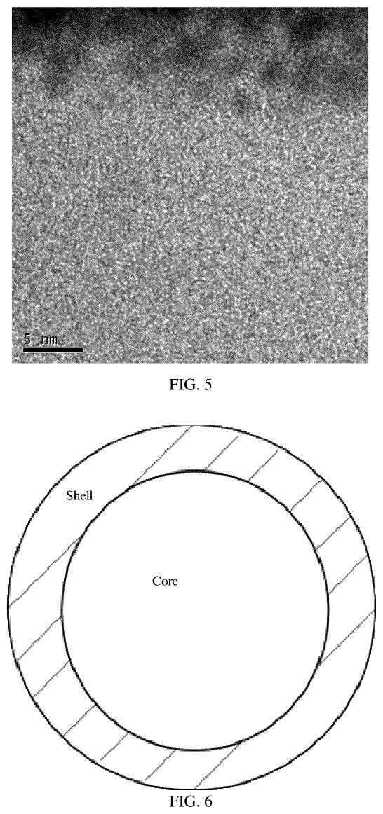

The coated material LiSi—C has a core-shell structure, where a core of the coated material LiSi—C is a material LiSi—C, and a shell of the coated material LiSi—C is an oxygen-containing coating layer. As shown in FIG. 5, it may be learned that the structure of the coated material LiSi—C is a core-shell structure, and there is a boundary between the core and the shell. A schematic structural diagram of the coated material LiSi—C is shown in FIG. 6.

In an example, at a position where a surface depth of the oxygen-containing coating layer of the coated material LiSi—C is less than 10 nm, a content of an element O is O₁ %; and at a position where a depth is greater than 100 nm, a content of the element O is O₂ %, where O₁ %≥35% (for example, 35%, 40%, 45%, 50%, 55%, 60%, 65%, or 70%) and O₁ %-O₂ %≥20% (for example, 20%, 25%, 30%, 35%, 40%, or 45%). Preferably, O₁ % ranges from 40% to 60% and O₁ %-O₂ %≥25%. For example, at a position where a surface depth of the oxygen-containing coating layer of the coated material LiSi—C is 10 nm, a content of the element O is O₁ %; and at a position where a depth is 100 nm, a content of the element O is O₂ %, where O₁ %≥35% and O₁ %-O₂ %≥20%. Preferably, O₁ % ranges from 40% to 60% and O₁ %-O₂ %≥25%.

Element analysis is performed on the oxygen-containing coating layer of the coated material LiSi—C by using X-ray photoelectron spectroscopy (XPS). At a position where a surface depth of the oxygen-containing coating layer of the coated material LiSi—C is 10 nm, a content of the element O is O₁ %, and at a position where a depth is 100 nm, a content of the element O is O₂ %. It may be understood that, as the surface depth of the oxygen-containing coating layer of the coated material LiSi—C increases from outside to inside, the content of the element O gradually decreases, that is, O₁ %>O₂ %. When the depth reaches a specific point, the content of the element O is O %≤10%, which means that the oxygen-containing coating layer ends at this position.

In an example, the coated material LiSi—C is in a form of particles, and a median particle size Dᵥ₅₀ ranges from 5 μm to 15 μm (for example, 5 μm, 6 μm, 7 μm, 8 μm, 9 μm, 10 μm, 11 μm, 12 μm, 13 μm, 14 μm, or 15 μm).

According to a specific implementation, the coated material LiSi—C has a porous structure.

In an example, a specific surface area of the coated material LiSi—C ranges from 1 m²/g to 5 m²/g (for example, 1 m²/g, 2 m²/g, 3 m²/g, 4 m²/g, or 5 m²/g).

Method for Preparing a Coated Material LiSi—C

The present disclosure provides a method for preparing the coated material LiSi—C by performing oxygen-containing coating modification processing on the material LiSi—C.

The oxygen-containing coating modification processing is performed on the material LiSi—C, so that an oxygen-containing coating layer may be formed on a surface of the material LiSi—C, thereby forming the coated material LiSi—C.

In an example, a method of the oxygen-containing coating modification processing may be performing high-temperature sintering, oxygen plasma surface processing, or oxygen-containing salt surface coating on the material LiSi—C.

In an example, the coated material LiSi—C is prepared by heating the material LiSi—C in air at a temperature ranging from 150° C. to 300° C. (for example, being 150° C., 170° C., 200° C., 230° C., 250° C., 280° C., or 300° C.) for 0.5 hour-1 hour (for example, 0.5 hour, 0.6 hour, 0.7 hour, 0.8 hour, 0.9 hour, or 1 hour).

In an example, the coated material LiSi—C is prepared by treating the material LiSi—C in an oxygen plasma atmosphere for 2 minutes-15 minutes (for example, 2 minutes, 5 minutes, 7 minutes, 10 minutes, 13 minutes, or 15 minutes).

The material LiSi—C may be prepared by using the method described in the present disclosure, that is, may be prepared by using a multi-step CVD vapor deposition method.

Electrode Plate

A second aspect of the present disclosure provides an electrode plate, the electrode plate includes a negative electrode current collector and a negative electrode active material layer coated on at least one side surface of the negative electrode current collector, the negative electrode active material layer includes a negative electrode active material, and the negative electrode active material includes graphite and the homogeneous silicon carbide material according to the first aspect of the present disclosure.

Except for the negative electrode active material, materials used in the electrode plate may be processed in a manner in the art. In this way, effect of good cycling performance and low expansion rate can be implemented, and a problem of tearing of a negative electrode current collector can be solved.

Because the negative active material in the electrode plate includes a homogeneous silicon carbide material and graphite, the homogeneous silicon carbide material has a bi-continuous phase structure, and this structure helps improve cycling stability of a battery.

In an example, the negative electrode current collector is copper foil or porous copper foil.

In an example, the negative electrode active material includes a homogeneous silicon carbide material and graphite.

In an example, the graphite includes artificial graphite and/or natural graphite.

In an example, the median particle size Dᵥ₅₀ of the graphite ranges from 5 μm to 20 μm, (for example, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm).

In an example, using a total weight of the negative electrode active material as a reference, a weight percentage of the graphite ranges from 45 wt % to 99 wt % (for example, 45 wt %, 50 wt %, 55 wt %, 60 wt %, 65 wt %, 70 wt %, 75 wt %, 80 wt %, 85 wt %, 90 wt %, 95 wt %, or 99 wt %), and a weight percentage of the homogeneous silicon carbide material ranges from 1 wt % to 55 wt % (for example, 1 wt %, 5 wt %, 10 wt %, 15 wt %, 20 wt %, 25 wt %, 30 wt %, 35 wt %, 40 wt %, 45 wt %, 50 wt %, or 55 wt %).

In an example, the negative electrode active material layer includes a negative electrode binder and a negative electrode conductive agent.

In an example, using a total weight of the negative electrode active material layer as a reference, a weight percentage of the negative electrode active material ranges from 80 wt % to 99.8 wt % (for example, 80 wt %, 82 wt %, 85 wt %, 87 wt %, 90 wt %, 92 wt %, 95 wt %, 97 wt %, or 99.8 wt %), a weight percentage of the negative electrode binder ranges from 0.1 wt % to 10 wt % (for example, 0.1 wt %, 0.5 wt %, 1 wt %, 3 wt %, 5 wt %, 7 wt %, or 10 wt %), and a weight percentage of the negative electrode conductive agent ranges from 0.1 wt % to 10 wt % (for example, 0.1 wt %, 0.5 wt %, 1 wt %, 3 wt %, 5 wt %, 7 wt %, or 10 wt %).

Preferably, using a total weight of the negative electrode active material layer as a reference, a weight percentage of the negative electrode active material ranges from 90 wt % to 98 wt %, a weight percentage of the negative electrode binder ranges from 1 wt % to 5 wt %, and a weight percentage of the negative electrode conductive agent ranges from 1 wt % to 5 wt %.

In an example, the negative electrode conductive agent is selected from a combination of one or more of conductive carbon black, carbon fiber, active carbon, acetylene black, graphene, super P, and a carbon nanotube.

In an example, the negative binder is selected from a combination of one or more of styrene-butadiene rubber, polyvinylidene fluoride, polytetrafluoroethylene, polyurethane, polyacrylic acid, sodium polyacrylate, polyvinyl alcohol, alginic acid, sodium alginate, CMC-Na, CMC-Li or PVP.

The present disclosure further provides a method for preparing the foregoing electrode plate, including the following steps.

Step 1: Adding the negative electrode active material, the negative electrode binder, and the negative electrode conductive agent to a stirring kettle, and stirring at a temperature ranging from 20° C. to 45° C. (for example, 20° C., 25° C., 30° C., 40° C., or 45° C.) for 6-18 hours (for example, 6 hours, 8 hours, 10 hours, 12 hours, 15 hours, 14 hours, 16 hours, or 18 hours) to obtain a negative electrode slurry with a solid content ranging from 30 wt % to 50 wt % (for example, 30 wt %, 35 wt %, 40 wt %, 45 wt %, or 50 wt %).

Step 2: Applying the prepared negative electrode slurry on at least one side of a surface of a negative electrode current collector, followed by drying and mill rolling, to obtain a negative electrode plate.

In an example, in Step 2, the negative electrode slurry is applied to at least one side of the negative electrode current collector with a thickness ranging from 20 μm to 100 μm, for example, 20 μm, 30 μm, 40 μm, 50 μm, 60 μm, 70 μm, 80 μm, 90 μm, or 100 μm.

Because the electrode plate of the present disclosure includes the homogeneous silicon carbide material described in the present disclosure, cycling stability of the electrode plate is improved, and an expansion rate of the electrode plate is reduced.

Battery

According to a third aspect of the present disclosure, a battery is provided, and the battery includes the electrode plate according to the second aspect of the present disclosure.

Except for the negative electrode plate, all materials of the battery may be performed in a manner in the art. In this way, effect of good rate performance and low deformation rate can be implemented.

In an example, the battery further includes a positive electrode plate, a separator, and an electrolyte solution.

In an example, the battery is a lithium-ion battery.

In an example, the positive electrode plate includes a positive electrode active material, and the positive electrode active material is selected from a combination of one of more of lithium iron phosphate, lithium manganese phosphate, lithium vanadium phosphate, lithium iron silicate, lithium cobalt oxide, nickel cobalt manganese ternary material, nickel-manganese/cobalt-manganese/nickel-cobalt binary material, lithium manganese oxide, or a lithium-rich manganese-based material.

In an example, the separator is a polyethylene polymer, a polypropylene polymer, or a nonwoven fabric.

In an example, the electrolyte solution is a non-aqueous electrolyte solution, the non-aqueous electrolyte solution includes a carbonate solvent and a lithium salt. The carbonate solvent is selected from a combination of one or more of ethylene carbonate (EC), propylene carbonate (PC), diethyl carbonate (DEC), fluoroethylene carbonate (FEC), dimethyl carbonate (DMC), or ethyl methyl carbonate (EMC), and the lithium salt is selected from a combination of one or more of LiPF₆, LiBF₄, LiSbF₆, LiClO₄, LiCF₃SO₃, LiAlO₄, LiAlCl₄, Li(CF₃SO₂)₂N, LiBOB, or LiDFOB.

Because the battery in the present disclosure includes the electrode plate described in the present disclosure, battery energy density is improved, battery expansion rate is reduced, battery cycling performance is improved, and a battery service life is prolonged.

The following describes the present disclosure in detail by using embodiments. The embodiments described in the present disclosure are merely some, but not all of the embodiments of the present disclosure. All other embodiments obtained by a person of ordinary skill in the art based on the embodiments of the present disclosure without creative efforts fall within the protection scope of the present disclosure.

Experimental methods used in the following examples are conventional methods, unless otherwise specified. Reagents, materials, and the like used in the following examples are all commercially available, unless otherwise specified.

### Example I Group

The Example I group is used to describe a negative electrode active material, an electrode plate, and a battery of the present disclosure.

### Example I-1

A negative electrode plate includes a negative electrode current collector and a negative electrode active material layer. The negative electrode active material layer is prepared by applying a negative electrode slurry on the negative electrode current collector. The negative electrode slurry includes a negative electrode active material (with an initial charge/discharge efficiency of 88% and a reversible specific capacity of 500 mAh/g), a negative electrode binder, and a negative electrode conductive agent. The negative electrode active material is a mixture of a homogeneous silicon carbide material and artificial graphite, and a mass ratio of the homogeneous silicon carbide material to the artificial graphite is 12:88.

The homogeneous silicon carbide material is obtained by using the following method:
continuously introducing silane gas (SiH₄) into a purchased mesoporous carbon material FDU-15 for 20 hours under a vacuum condition of 100 Pa at 450° C., then raising the temperature to 650° C. and introducing ethylene gas for 30 minutes, and cooling the material under protection of argon.

The homogeneous silicon carbide material is a silicon carbide material formed by an element Si and an element C and having a bi-continuous phase structure, where a median particle size Dᵥ₅₀ is 8 μm, a specific surface area is 5.4 m²/g, and a mass percentage of the element C in the homogeneous silicon carbide material is 50.2 wt %.

The negative electrode binder is lithium carboxymethyl cellulose (CMC-Li) and styrene-butadiene rubber (SBR), water is used as a solvent, and the conductive agent is super P (SP) and single-walled carbon nanotubes (SWCNTs). A mass ratio of the negative electrode active material:CMC-Li:SBR:SP:SWCNTs is 96:1.5:1.5:0.9:0.1, and the negative electrode current collector is copper foil.

A method for preparing a negative electrode plate includes the following steps:
Step 1: adding the negative electrode active material, the negative electrode binder, and the negative electrode conductive agent to a dispersing agent in a ratio by mass, and stirring the mixture at 20° C. for 18 hours to obtain a negative electrode slurry with a solid content ranging from 30% to 50%; and
Step 2: applying the negative electrode slurry on a surface of a negative electrode current collector, followed by drying and mill rolling, to obtain the negative electrode plate.

A battery including the negative electrode plate includes a positive electrode plate, a separator, an electrolyte solution, an aluminum-plastic film, and the negative electrode plate.

The positive electrode plate includes a positive electrode active material, the positive electrode active material is 4.45 V lithium cobalt oxide positive electrode (LiCoO₂), with an initial charge/discharge efficiency of 95%, polyvinylidene fluoride (PVDF) is used as a binder, N-methylpyrrolidone (NMP) is used as a solvent, and SP (super P) and carbon nanotubes (CNTs) are used as a composite conductive agent. A mass ratio of the positive electrode active material:PVDF:SP:CNTs is 96:2:1.5:0.5. After processes of stirring, coating, rolling, cutting, and manufacturing, the positive electrode plate is prepared.

The separator is a polyethylene separator, the electrolyte solution is a non-aqueous electrolyte solution, and the non-aqueous electrolyte solution includes a carbonate solvent and a lithium salt. The carbonate solvent is ethylene carbonate (EC), and the lithium salt is LiPF₆.

A size of the negative electrode plate is greater than that of the positive electrode plate, and a reversible specific capacity per unit area of the negative electrode plate is 5% higher than that of the positive electrode plate.

The positive electrode plate and the negative electrode plate are stacked and assembled, tabs are welded, and an aluminum-plastic film is packaged. The top side is sealed, and vacuum baking is performed to remove moisture. After a moisture standard is met, electrolyte injection, standing, and formation are successively performed, followed by sealing for the second time in vacuum, and sorting.

Under charge and discharge conditions of 25° C. and 0.5 C, a battery sorting energy density reaches 820 Wh/L. After 500 cycles at 0.5 C, a capacity retention rate is 83.3%, and a battery expansion rate is 8.3%.

### Comparative Example I-1

Other operations are the same as those in Example I-1. Differences are merely as follows.

The negative electrode slurry includes a negative electrode active material (with an initial charge/discharge efficiency of 88% and a reversible specific capacity of 500 mAh/g). The negative electrode active material is a mixture of conventional SiC and graphite, and a mass ratio of the conventional SiC to the graphite is 12:88.

A size of the negative electrode plate is greater than that of the positive electrode plate, and a reversible capacity per unit area of the negative electrode plate is 6% higher than that of the positive electrode plate.

Under charge and discharge conditions of 25° C. and 0.5 C, a battery sorting energy density reaches 820 Wh/L. After 500 cycles at 0.5 C, a capacity retention rate is 71.3%, and a battery expansion rate is 16%.

### Example I-2

Other operations are the same as those in Example I-1. Differences are merely as follows.

The negative electrode slurry includes a negative electrode active material (with an initial charge/discharge efficiency of 88% and a reversible specific capacity of 550 mAh/g), a negative electrode binder, and a negative electrode conductive agent. The negative electrode active material is a mixture of a homogeneous silicon carbide material and artificial graphite, and a mass ratio of the homogeneous silicon carbide material to the artificial graphite is 3:7.

The homogeneous silicon carbide material is obtained by using the following method:
continuously introducing silane gas (SiH₄) into a purchased JiCang nano-porous carbon material MC-1 for 15 hours under a vacuum condition of 20 kPa at 450° C., then raising the temperature to 600° C. and introducing acetylene gas for 25 minutes, and cooling the material under protection of argon.

The homogeneous silicon carbide material is a silicon carbide material formed by an element Si and an element C and having a bi-continuous phase structure, where a median particle size Dᵥ₅₀ is 10 μm, a specific surface area is 8.1 m²/g, and a mass percentage of the element C in the homogeneous SiC material is 45.3 wt %.

A mass ratio of the negative electrode active material:CMC-Li:SBR:SP:SWCNTs is 95:1.5:2:1.3:0.2.

The positive electrode active material is a ternary material LiNi_{0.8}Co_{0.1}Mn_{0.1}O₂, and an initial charge/discharge efficiency is 89%.

A size of the negative electrode plate is greater than that of the positive electrode plate, and a reversible specific capacity per unit area of the negative electrode plate is 12% higher than that of the positive electrode plate.

Under charge and discharge conditions of 25° C. and 0.5 C, a battery sorting energy density may reach 320 Wh/kg. After 800 cycles at 0.5 C, a capacity retention rate is 82.6%, and a battery expansion rate is 11.3%.

### Comparative Example I-2

Other operations are the same as those in Example I-2. Differences are merely as follows.

The negative electrode slurry includes a negative electrode active material (with an initial charge/discharge efficiency of 79% and a reversible specific capacity of 550 mAh/g). The negative electrode active material is a mixture of SiO_{1.1} and artificial graphite, a mass ratio of the SiO_{1.1} to the artificial graphite is 3:7, and the SiO_{1.1} is a nanometer composite of silicon and SiO₂.

Under charge and discharge conditions of 25° C. and 0.5 C, a battery sorting energy density reaches 300 Wh/kg. After 800 cycles at 0.5 C, a capacity retention rate is 70.5%, and a battery expansion rate is 17.4%.

### Example I-3

Other operations are the same as those in Example I-1. Differences are merely as follows.

The negative electrode slurry includes a negative electrode active material (with an initial charge/discharge efficiency of 90% and a reversible specific capacity of 450 mAh/g). The negative electrode active material is a mixture of a homogeneous SiC material and artificial graphite, and a mass ratio of the homogeneous SiC material to the artificial graphite is 7:93.

The homogeneous SiC material is obtained by using the following method:
continuously introducing silane gas (SiH₄) into a purchased mesoporous carbon material CMK-3 for 12 hours under a vacuum condition of 10 kPa at 450° C., then raising the temperature to 650° C. and introducing ethylene gas for 30 minutes, and cooling the material under protection of argon.

The homogeneous silicon carbide material is a silicon carbide material formed by an element Si and an element C and having a bi-continuous phase structure, where a median particle size Dᵥ₅₀ is 11 μm, a specific surface area is 9.1 m²/g, and a mass percentage of the element C in the homogeneous silicon carbide material is 47.2 wt %.

The electrolyte solution is a non-aqueous electrolyte solution, and the non-aqueous electrolyte solution includes a carbonate solvent and a lithium salt. The carbonate solvent is ethylene carbonate (EC), and the lithium salt is LiTFSI and LiPF₆.

Under conditions of 25° C. and charge at 3 C and discharge at 0.5 C, a battery sorting energy density may reach 730 Wh/L. After 600 cycles at 3 C, a capacity retention rate is 80.3%, and a battery expansion rate is 9.3%.

### Comparative Example I-3

Other operations are the same as those in Example I-3. Differences are merely as follows:

The negative electrode slurry includes a negative electrode active material (with an initial charge/discharge efficiency of 90% and a reversible specific capacity of 450 mAh/g). The negative electrode active material is a mixture of a conventional SiC material and artificial graphite, and a mass ratio of the conventional SiC material to the artificial graphite is 7:93.

A size of the negative electrode plate is greater than that of the positive electrode plate, and a reversible specific capacity per unit area of the negative electrode plate is 6% higher than that of the positive electrode plate.

Under conditions of 25° C. and charge at 3 C and discharge at 0.5 C, a battery sorting energy density reaches 730 Wh/L. After 600 cycles at 3 C, a capacity retention rate is 68.3%, and a battery expansion rate is 14.5%.

### Test Example I

### Test Example I-1

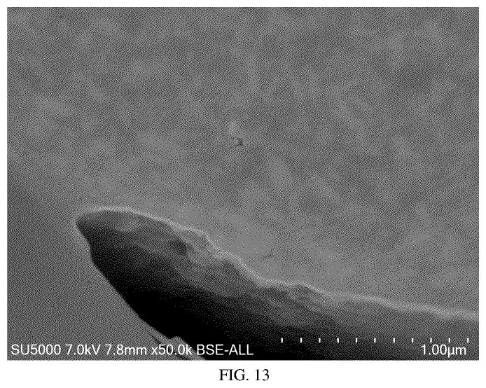

The homogeneous silicon carbide material obtained in Example I-1 was tested by X-ray diffraction and SEM separately, to obtain an XRD pattern of the homogeneous silicon carbide material shown in FIG. 1 and an SEM cross-sectional view of the homogeneous silicon carbide material shown in FIG. 2, respectively. SEM is performed on a conventional SiC material obtained in Comparative Example I-1, to obtain an SEM cross-sectional view of the conventional SiC material shown in FIG. 13.

FIG. 1 is an XRD pattern of the homogeneous silicon carbide material in Example I-1 of the present disclosure. It may be learned from FIG. 1 that, in an X-ray diffraction pattern of the homogeneous silicon carbide material, a maximum intensity of a broad peak occurs when 2θ is in a range from 20° to 40° is I₁, and a maximum intensity of a broad peak occurs when 2θ is in a range from 40° to 60° is I₂, where I₁>I₂.

FIG. 2 is an SEM cross-sectional view of the homogeneous silicon carbide material in Example I-1 of the present disclosure. It may be learned from FIG. 2 that, an internal structure of particles is a homogeneous structure at 50K magnification, and there is no phase separation between silicon and carbon in structure, that is, there is no distinct boundary between the two components at a microstructural level. The homogeneous silicon carbide material has a bi-continuous phase structure.

FIG. 13 is an SEM cross-sectional view of a conventional SiC material in Comparative Example I-1 of the present disclosure. It may be learned from FIG. 13 that, internal Si/C phases of particles at 50K magnification (light color represents a Si phase component, and dark color represents a carbon phase component) indicate that the conventional SiC material is secondary large particles composed of carbon composite with individual silicon nanoparticles, and there is obvious phase separation between silicon and carbon in the material, that is, there is still a distinct boundary between the two components at a microstructural level.

### Test Example I-2

(1) Carbon Content Test in a SiC Material

A carbon-sulfur analyzer is used to measure a carbon content in the SiC material.

(2) Carbon Content Difference in SiC Particles

The cross sections of negative electrode plates are polished by using Ar particles, and SEM and EDS are selected to test the cross sections of the negative electrode plates in examples and comparative examples. Mass ratios C_{A}, C_{B}, C_{C}, and C_{D} of an element C at any four points A, B, C, and D in a region where any five SiC material particles are 100 nm away from a surface of the SiC material particles are calculated by using SEM and EDS, then |Cₙ−Cₘ| (n and m are any two points of A, B, C, and D) is calculated for any two mass ratios, and then an average value of Max|Cₙ−Cₘ| for the five particles is taken.

(3) Capacity Retention Rate after 500/600/800 Cycles

Test steps: At room temperature, a battery is charged to 4.45 V at a constant current 0.5 C or 3 C and then charged to a cut-off current 0.05 C at a constant voltage 4.45 V. Then the battery is discharged to a cut-off voltage 3.0 V at 0.5 C. After 500/600/800 cycles, a capacity retention rate is calculated according to following formula:

Capacity retention rate=Cut-off capacity/Initial capacity*100%.

(4) Expansion Rate after Cycling

Test steps: At room temperature, a battery is charged to 4.45 V at a constant current 0.5 C or 3 C and then charged to a cut-off current 0.05 C at a constant voltage 4.45 V. Then the battery is discharged to a cut-off voltage 3.0 V at 0.5 C. After a specific circle (500/600/800 cycles, specifically as shown in Table I-1), an expansion rate is calculated according to following formula:

Expansion rate=(THK₁−THK₀)/THK₀×100%

where THK₀ is a thickness of a battery measured by 600 g PPG at an initial voltage 3.85 V, and THK₁ is a thickness of a fully-charged battery obtained after cycling.

TABLE I-1
Performance test results of negative electrode active materials and batteries in Examples and Comparative Examples

| | Negative electrode | | | Capacity | | |
|---|---|---|---|---|---|---|
| | specific capacity | Carbon | | retention | Expansion | |
| | (mAh/g) | content | MAX_{\|Cn-Cm\|} | rate | rate | Cycles |
| Example I-1 | 500 | 50.2% | 6.5% | 83.3% | 8.3% | 500 |
| Comparative | 500 | 70.3% | 55.3% | 71.3% | 16% | 500 |
| Example I-1 | | | | | | |
| Example I-2 | 550 | 45.3% | 8.3% | 82.6% | 11.3% | 800 |
| Comparative | 550 | 4.35% | — | 70.5% | 17.4% | 800 |
| Example I-2 | | | | | | |
| Example I-3 | 450 | 47.2% | 7.1% | 80.3% | 9.3% | 600 |
| Comparative | 450 | 65% | 61.3% | 68.3% | 14.5% | 600 |
| Example I-3 | | | | | | |

It may be seen from Table I-1 that, compared with a conventional SiC material, the homogenized silicon carbide material in the present disclosure has better cycling performance and a high specific capacity, so that electrolyte solution consumption, side reaction, and expansion during cycling can be reduced, and problems such as low initial Coulombic efficiency, rapid capacity attenuation and high expansion during cycling in a high-ratio composite negative electrode may be effectively solved, thereby significantly improving energy density and a cyclic life of the battery. Thus, the homogeneous silicon carbide material is suitable for large-scale commercial production.

### Example II Group

The Example II group is used to describe a material LiSi—C, an electrode plate, and a battery of the present disclosure.

### Example II-1

Preparation of the Material LiSi—C:
continuously introducing lithium vapor into a purchased mesoporous carbon material FDU-15 under a vacuum condition of 10⁻³ Pa at 300° C., and stopping the introduction of lithium vapor after 60 minutes; after adjusting a furnace pressure to 101 kPa and raising the temperature to 450° C., introducing silane gas (SiH₄) and maintaining for 12 hours before stopping the introduction of silane gas; then raising the temperature to 650° C. and introducing ethylene gas for 30 minutes before stopping the introduction of ethylene gas; and naturally cooling the material under protection of argon to obtain the material LiSi—C.

A weight ratio of the material LiSi—C to graphite is 12:88.

### Example II-2

Preparation of the Material LiSi—C:
continuously introducing lithium vapor into a purchased JiCang nano-porous carbon material MC-1 under a vacuum condition of 10⁻³ Pa at 350° C., and stopping the introduction of lithium vapor after 60 minutes; after adjusting a furnace pressure to 80 kPa and raising the temperature to 430° C., introducing silane gas (SiH₄) and maintaining for 12 hours before stopping the introduction of silane gas; then raising the temperature to 650° C. and introducing ethylene gas for 30 minutes before stopping the introduction of ethylene gas; and naturally cooling the material under protection of argon to obtain the material LiSi—C.

A weight ratio of the material LiSi—C to graphite is 30:70.

### Example II-3

Other steps are the same as those in Example II-1, and a difference lies in that a weight ratio of the material LiSi—C to graphite is changed to 7:93.

### Comparative Example II-1

Other steps are the same as those in Example II-1, and a difference lies in that a mixture of a conventional SiC material and graphite is used.

### Preparation Example

The materials LiSi—C obtained in Examples II-1, II-2, II-3, and Comparative Example II-1 and a conventional SiC material are separately used to prepare a battery in the following manner.

(1) Preparation of a Negative Electrode Plate

Material Preparation:
negative electrode binder: lithium carboxymethyl cellulose (CMC-Li) and styrene-butadiene rubber (SBR);
solvent: water;
conductive agent: super P (SP) and single-walled carbon nanotubes (SWCNTs);
negative electrode current collector: copper foil; and
negative electrode active material layer: formed according to a weight ratio of (material LiSi—C and graphite): CMC-Li:SBR:SP:SWCNTs being 96:1.5:1.5:0.9:0.1.

Preparation: adding the negative electrode active material, the negative electrode binder, and a negative electrode conductive agent to a dispersing agent according to the weight ratio, and stirring for 18 hours at 20° C. to obtain a negative electrode slurry with a solid content ranging from 30% to 50%; and applying the negative electrode slurry on both sides of the negative electrode current collector, followed by drying and rolling to obtain a negative electrode plate.

(2) Preparation of a Positive Electrode Plate

Material Preparation:
binder: polyvinylidene fluoride (PVDF);
solvent: N-methylpyrrolidone (NMP); and
conductive agent: SP (super P) and carbon nanotubes (CNTs); and
positive electrode active material layer: formed according to a weight ratio of 4.45 V lithium cobalt oxide positive electrode (LiCoO₂):PVDF:SP:CNTs being 96:2:1.5:0.5.

Preparation: mixing the positive electrode active material, the binder, the solvent, and a composite conductive agent by the weight ratio, followed by stirring, coating, rolling, cutting, and manufacturing, to obtain the positive electrode plate.

(3) Separator

The separator is a polyethylene separator.

(4) Electrolyte Solution

The electrolyte solution is a non-aqueous electrolyte solution, including ethyl carbonate (EC) and LiPF₆.

(5) Battery Preparation

allowing a size of the negative electrode plate to be greater than that of the positive electrode plate; stacking and assembling the negative electrode plate in step (1) and the positive electrode plate in step (2), welding tabs, and packaging an aluminum-plastic film; sealing the top side, and performing vacuum baking to remove moisture; and after a moisture standard is met, successively performing electrolyte injection, standing, and formation, followed by sealing for the second time in vacuum, and sorting, to obtain the battery.

### Test Example II

### Test Example II-1

The material LiSi—C obtained in Example II-1 was tested by SEM and X-ray diffraction separately, to obtain an SEM cross-sectional view of the material LiSi—C shown in FIG. 3 and an XRD pattern of the material LiSi—C shown in FIG. 4, respectively.

FIG. 3 is an SEM cross-sectional view of a material LiSi—C at 50K magnification, where light color represents an internal structure of a LiSi—C particle, and dark color represents a gap between LiSi—C particles. It may be learned from FIG. 3 that, at 50K magnification, an internal structure of LiSi—C particles is homogeneous, and there is no distinct boundary between a LiSi phase and a C phase.

It may be learned from FIG. 4 that, there are two characteristic peaks in the XRD pattern of the material LiSi—C, which are respectively characteristic peak 1 occurred when 2θ is in a range from 23° to 24° and having a maximum intensity denoted as I₃, and characteristic peak 2 occurred when 2θ is in a range from 41° to 42° and having a maximum intensity denoted as I₄, where I₃>I₄.

### Test Example II-2

A test for carbon content in Si-based materials and a carbon content difference test for Si-based particles are separately performed on the Si-based materials in examples and comparative examples. An initial charge/discharge efficiency test for a battery cell, a test for capacity retention rate after 500/600/800 cycles, and a test for expansion rate after cycling are separately performed on batteries obtained in examples and comparative examples.

(1) Test for Carbon Content in Si-Based Materials

A carbon-sulfur analyzer is used to measure a carbon content in a Si-based material.

(2) Carbon Content Difference Test for Si-Based Particles

The cross sections of negative electrode plates are polished by using Ar particles, and SEM and EDS are selected to test the cross sections of the negative electrode plates in examples and comparative examples. Mass ratios C_{A}, C_{B}, C_{C}, and C_{D} of an element C at any four points A, B, C, and D in a region where any five LiSi—C particles are 100 nm away from a surface of the LiSi—C particles are calculated by using SEM and EDS, then |Cₙ−Cₘ| (n and m are any two points of A, B, C, and D) is calculated for any two mass ratios, and then an average value of Max|Cₙ−Cₘ| for the five particles is taken.

(3) Initial Charge/Discharge Efficiency Test for a Battery Cell

After being injected with electrolyte solution and aged, a battery cell is charged at 0.1 C to 4.48 V at 25° C., and then charged to a cut-off current 0.025 C to obtain a charge capacity. Then the battery cell is discharged to 3.0 V at 0.1 C to obtain a discharge capacity.

Initial charge/discharge efficiency=Discharge capacity/Charge capacity*100%

(4) Test for Capacity Retention Rate after 500/600/800 Cycles

At room temperature, a battery is charged to 4.48 V at a constant current of 0.5 C or 3 C and then charged to a cut-off current 0.05 C at a constant voltage 4.48 V. Then the battery is discharged to 3.0 V at 0.5 C. After 500/600/800 cycles, a capacity retention rate is calculated according to following formula:

Capacity retention rate=Cut-off capacity/Initial capacity*100%.

(5) Test for Expansion Rate after Cycling

At room temperature, a battery is charged to 4.48 V at a constant current of 0.5 C or 3 C and then charged to a cut-off current 0.05 C at a constant voltage 4.48 V. Then the battery is discharged to a cut-off voltage 3.0 V at 0.5 C. After a specific circle (500/600/800 cycles, specifically as shown in Table II-1), an expansion rate is calculated according to following formula:

Expansion rate=(THK₁−THK₀)/THK₀×100%

where THK₀ is a thickness of a battery measured by 600 g PPG at an initial voltage 3.85 V, and THK₁ is a thickness of a fully-charged battery obtained after cycling.

The obtained results are recorded in Table II-1.

TABLE II-1

| | Negative | Initial | | | | | | |
|---|---|---|---|---|---|---|---|---|
| | electrode | charge/ | Battery | | | | | |
| | specific | discharge | cell | Carbon | | Capacity | | |
| | capacity | efficiency | energy | content | | retention | Expansion | |
| | (mAh/g) | (%) | density | (%) | MAX_{\|Cn-Cm\|} | rate (%) | rate (%) | Cycles |
| Example II-1 | 500 | 91 | 825 | 48.2% | 5.5% | 81.3% | 9.3% | 500 |
| Example II-2 | 550 | 89 | 315 | 43.3% | 7.3% | 80.6% | 11.9% | 800 |
| Example II-3 | 450 | 92 | 745 | 47.2% | 6.9% | 82.3% | 9.8% | 600 |
| Comparative | 500 | 88 | 800 | 70.3% | 55.3% | 71.3% | 16% | 500 |
| Example II-1 | | | | | | | | |

It may be learned from Table II-1 by comparing comparative examples and examples that, for a battery after cycling in the examples, the expansion rate is significantly reduced, the capacity retention rate is significantly improved, and the initial charge/discharge efficiency is relatively high.

### Example III Group

The Example III group is used to describe a coated material LiSi—C, an electrode plate, and a battery of the present disclosure.

### Example III-1

Preparation of the Coated Material LiSi—C:
continuously introducing lithium vapor into a purchased mesoporous carbon material FDU-15 under a vacuum condition of 10⁻³ Pa at 350° C., and stopping the introduction of lithium vapor after 60 minutes; after adjusting a furnace pressure to 101 kPa and raising the temperature to 450° C., introducing silane gas (SiH₄) and maintaining for 6 hours before stopping the introduction of silane gas; then raising the temperature to 650° C. and introducing ethylene gas for 30 minutes before stopping the introduction of ethylene gas; naturally cooling the material under protection of argon to obtain LiSi—C particles; and heating the obtained LiSi—C particles in air at 170° C. for 1 hour to obtain the coated material LiSi—C.

A weight ratio of the coated material LiSi—C to graphite is 12:88.

### Example III-2

Preparation of the Coated Material LiSi—C:
continuously introducing lithium vapor into a purchased JiCang nano-porous carbon material MC-1 under a vacuum condition of 10⁻³ Pa at 350° C., and stopping the introduction of lithium vapor after 60 minutes; after adjusting a furnace pressure to 80 kPa and raising the temperature to 430° C., introducing a mixed gas of silane gas (SiH₄) and ethylene, and maintaining for 12 hours before stopping the introduction of the mixed gas; then raising the temperature to 650° C. and introducing ethylene gas for 30 minutes before stopping the introduction of ethylene gas; naturally cooling the material under protection of argon to obtain the material LiSi—C; and processing the obtained material LiSi—C in an oxygen plasma atmosphere for 5 minutes to obtain the coated material LiSi—C.

A weight ratio of the coated material LiSi—C to graphite is 30:70.

### Example III-3

Other steps are the same as those in Example III-1, and a difference lies in that a weight ratio of the coated material LiSi—C to graphite is changed to 7:93.

### Comparative Example III-1

Other steps are the same as those in Example III-1, and a difference lies in that the LiSi—C particles are not heated in air.

### Comparative Example III-2

Other steps are the same as those in Example III-2, and a difference lies in that oxygen plasma processing is not performed.

### Comparative Example III-3

Other steps are the same as those in Example III-1, and a difference lies in that graphite is mixed with a conventional SiC material.

### Preparation Example

The materials obtained in Examples III-1, III-2, III-3, and Comparative Examples III-1, III-2, and III-3 are separately used to prepare a battery in the following manner.

(1) Preparation of a Negative Electrode Plate

Material Preparation:
negative electrode binder: lithium carboxymethyl cellulose (CMC-Li) and styrene-butadiene rubber (SBR);
negative electrode conductive agent: Super P (SP) and single-walled carbon nanotube (SWCNTs); and
negative electrode active material layer: formed according to (coated material LiSi—C and graphite): CMC-Li:SBR:SP:SWCNTs being 96:1.5:1.5:0.9:0.1;
solvent: water; and
negative electrode current collector: copper foil.

Preparation: adding the negative electrode active material and the solvent to a dispersing agent according to the weight ratio, and stirring for 18 hours at 20° C. to obtain a negative electrode slurry with a solid content ranging from 30% to 50%; and applying the negative electrode slurry on both sides of the negative electrode current collector, followed by drying and rolling to obtain a negative electrode plate.

(2) Preparation of a Positive Electrode Plate

Material Preparation:
binder: polyvinylidene fluoride (PVDF);
solvent: N-methylpyrrolidone (NMP);
conductive agent: SP (super P) and carbon nanotubes (CNTs); and
positive electrode active material layer: formed according to a weight ratio of 4.45 V lithium cobalt oxide positive electrode (LiCoO₂):PVDF:SP:CNTs being 96:2:1.5:0.5.

Preparation: mixing the positive electrode active material and the solvent by the weight ratio, followed by stirring, coating, rolling, cutting, and manufacturing, to obtain the positive electrode plate.

(3) Separator

The separator is a polyethylene separator.

(4) Electrolyte Solution

The electrolyte solution is a non-aqueous electrolyte solution, including ethyl carbonate (EC) and LiPF₆.

(5) Battery Preparation
allowing a size of the negative electrode plate to be greater than that of the positive electrode plate; stacking and assembling the negative electrode plate in step (1) and the positive electrode plate in step (2), welding tabs, and packaging an aluminum-plastic film; sealing the top side, and performing vacuum baking to remove moisture; and after a moisture standard is met, successively performing electrolyte injection, standing, and formation, followed by sealing for the second time in vacuum, and sorting, to obtain the battery.

### Test Example III

### Test Example III-1

A TEM test is performed on the coated material LiSi—C obtained in Example III-1, and a TEM diagram of the coated material LiSi—C is shown in FIG. 5.

It may be learned from FIG. 5 that a structure of the coated material LiSi—C includes two parts: light part and dark part, and there is a boundary between the light part and the dark part. Therefore, the structure of the coated material LiSi—C is a core-shell structure.

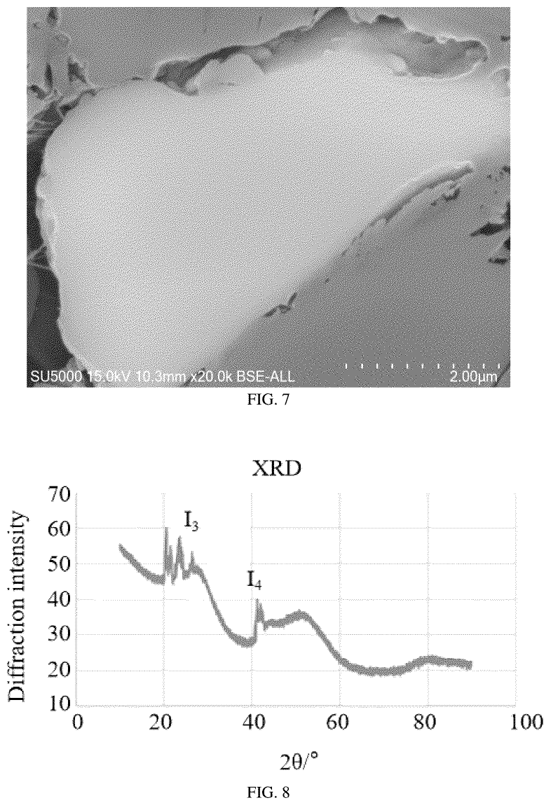

The coated material LiSi—C obtained in Example III-1 was tested by SEM and X-ray diffraction separately, to obtain an SEM cross-sectional view of the coated material LiSi—C shown in FIG. 7 and an XRD pattern of the coated material LiSi—C shown in FIG. 8, respectively.

FIG. 7 is an SEM cross-sectional view of a coated material LiSi—C at 50K magnification, where light color represents an internal structure of the coated material LiSi—C, and dark color represents a gap between LiSi—C particles. It may be learned from FIG. 7 that, at 50K magnification, an internal structure of coated material LiSi—C particles is homogeneous, and there is no distinct boundary between a LiSi phase and a C phase.

It may be learned from FIG. 8 that, there are two characteristic peaks in the XRD pattern of the coated material LiSi—C, which are respectively characteristic peak 1 occurred when 2θ is in a range from 23° to 24° and having a maximum intensity denoted as I₃, and characteristic peak 2 occurred when 2θ is in a range from 41° to 42° and having a maximum intensity denoted as I₄, where I₃>I₄.

### Test Example III-2

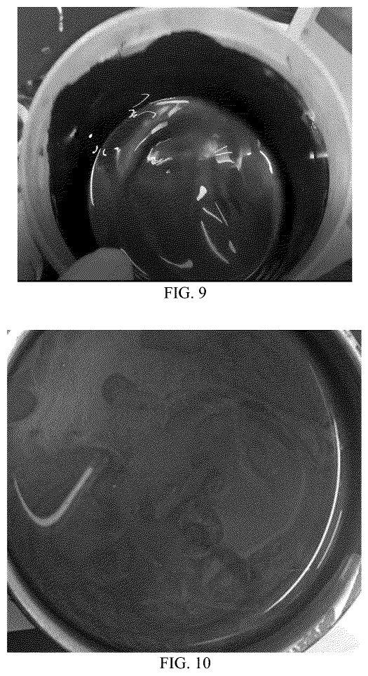

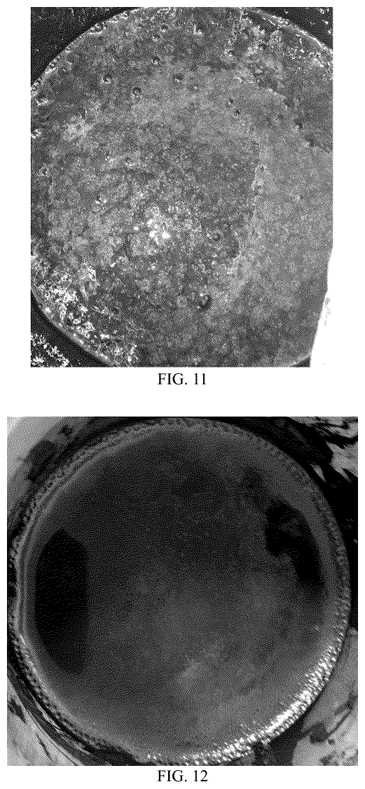

The negative electrode slurries prepared in Examples and Comparative Examples are compared and tested. The negative electrode slurries obtained in Example III-1, Example III-2, Comparative Example III-1, and Comparative Example III-2 are respectively shown in FIG. 9, FIG. 10, FIG. 11, and FIG. 12. It may be learned from comparison that air bubbles exist in the negative electrode slurries obtained in Comparative Example III-1 and Comparative Example III-2, especially in the negative electrode slurry obtained in Comparative Example III-1. Therefore, stability of the negative electrode slurries obtained in Comparative Example III-1 and Comparative Example III-2 is low, while the negative electrode slurries obtained in Example III-1 and Example III-2 are more uniform and have no air bubbles. Therefore, the negative electrode slurries obtained in Example III-1 and Example III-2 have higher stability.

### Test Example III-3

A test for carbon content in Si-based materials and a carbon content difference test for Si-based particles are separately performed on the Si-based materials in examples and comparative examples. An initial charge/discharge efficiency test for a battery cell, a test for capacity retention rate after 500/600/800 cycles, and a test for expansion rate after cycling are separately performed on batteries obtained in examples and comparative examples.

(1) Test for Carbon Content in Si-Based Materials

A carbon-sulfur analyzer is used to measure a carbon content in a Si-based material.

(2) Carbon Content Difference Test for Si-Based Particles

The cross sections of negative electrode plates are polished by using Ar particles, and SEM and EDS are selected to test the cross sections of the negative electrode plates in examples and comparative examples. Mass ratios C_{A}, C_{B}, C_{C}, and C_{D} of an element C at any four points A, B, C, and D in a region where any five LiSi—C particles are 100 nm away from a surface of the LiSi—C particles are calculated by using SEM and EDS, then |Cₙ−Cₘ| (n and m are any two points of A, B, C, and D) is calculated for any two mass ratios, and then an average value of Max|Cₙ−Cₘ| for the five particles is taken.

(3) Initial Charge/Discharge Efficiency Test for a Battery Cell

After being injected with electrolyte solution and aged, a battery cell is charged at 0.1 C to 4.48 V at 25° C., and then charged to a cut-off current 0.025 C to obtain a charge capacity. Then the battery cell is discharged to 3.0 V at 0.1 C to obtain a discharge capacity.

Initial charge/discharge efficiency=Discharge capacity/Charge capacity*100%

(4) Test for Capacity Retention Rate after 500/600/800 Cycles

At room temperature, a battery is charged to 4.48 V at a constant current of 0.5 C or 3 C and then charged to a cut-off current 0.05 C at a constant voltage 4.48 V. Then the battery is discharged to 3.0 V at 0.5 C. After 500/600/800 cycles, a capacity retention rate is calculated according to following formula:

Capacity retention rate=Cut-off capacity/Initial capacity*100%.

(5) Test for Expansion Rate after Cycling

At room temperature, a battery is charged to 4.48 V at a constant current of 0.5 C or 3 C and then charged to a cut-off current 0.05 C at a constant voltage 4.48 V. Then the battery is discharged to a cut-off voltage 3.0 V at 0.5 C. After a specific circle (500/600/800 cycles, specifically as shown in Table III-1), an expansion rate is calculated according to following formula:

Expansion rate=(THK₁−THK₀)/THK₀×100%

where THK₀ is a thickness of a battery measured by 600 g PPG at an initial voltage 3.85 V, and THK₁ is a thickness of a fully-charged battery obtained after cycling.

(6) XPS Surface Analysis and Depth Analysis

Surface XPS element analysis is performed on the coated material LiSi—C, and at a position where a surface depth of the oxygen-containing coating layer is 10 nm, a content of the element O is O₁ %, and at a position where a depth is 100 nm, a content of the element O is O₂ %.

The obtained results are recorded in Table III-1.

TABLE III-1

| | Negative | Initial | | | | | | | |
|---|---|---|---|---|---|---|---|---|---|
| | electrode | charge/ | Battery | | | | | | |
| | specific | discharge | cell | | | | Capacity | | |
| | capacity | efficiency | energy | Carbon | | | retention | Expansion | |
| | (mAh/g) | (%) | density | content | O₁%:O₁%-O₂% | MAX_{\|Cn-Cm\|} | rate | rate | Cycles |
| Example | 490 | 90 | 820 Wh/L | 47.9% | 40%:22% | 5.1% | 82.5% | 8.8% | 500 |
| III-1 | | | | | | | | | |
| Example | 540 | 88 | 310 | 43.0% | 37.5%:26% | 7.6% | 81.9% | 11.3% | 800 |
| III-2 | | | WH/kg | | | | | | |
| Example | 440 | 91 | 735 Wh/L | 46.9% | 34%:23% | 6.4% | 82.3% | 9.8% | 600 |
| III-3 | | | | | | | | | |
| Comparative | 500 | 91 | 825 Wh/L | 48.2% | 28%:10% | 5.5% | 81.3% | 9.3% | 500 |
| Example | | | | | | | | | |
| III-1 | | | | | | | | | |
| Comparative | 550 | 89 | 315 | 43.3% | 31%:13% | 7.3% | 80.6% | 11.9% | 800 |
| Example | | | WH/kg | | | | | | |
| III-2 | | | | | | | | | |
| Comparative | 500 | 88 | 800 Wh/L | 70.3% | \ | 55.3% | 71.3% | 16% | 500 |
| Example | | | | | | | | | |
| III-3 | | | | | | | | | |

It may be learned from Table III-1 by comparing comparative examples and examples that, for a battery after cycling in the examples, the expansion rate is significantly reduced, the capacity retention rate is significantly improved, and the slurries have good stability.

The foregoing describes in detail a preferred implementation of the present disclosure. However, the present disclosure is not limited thereto. Within the scope of the technical concepts of the present disclosure, various simple variations may be implemented to the technical solutions of the present disclosure, including combinations of technical features in any other suitable manner. These simple variations and combinations shall also be considered as the disclosure of the present disclosure and shall fall within the protection scope of the present disclosure.

What is claimed is:

1. A homogeneous silicon carbide material, wherein the homogeneous silicon carbide material comprises an element Si and an element C, and the homogeneous silicon carbide material is a homogeneous material and has a bi-continuous phase structure.

2. The homogeneous silicon carbide material according to claim 1, wherein in an X-ray diffraction pattern of the homogeneous silicon carbide material, a maximum intensity of a broad peak occurs when 2θ is in a range from 20° to 40° is I₁, and a maximum intensity of a broad peak occurs when 2θ is in a range from 40° to 60° is I₂, wherein I₁>I₂.

3. The homogeneous silicon carbide material according to claim 1, wherein in a region that is inside the homogeneous silicon carbide material and 100 nm away from a surface of the homogeneous silicon carbide material, mass proportions C_{A} and C_{B} of the element C at any two positions A and B satisfy: |C_{A}−C_{B}|≤15%.

4. The homogeneous silicon carbide material according to claim 1, wherein a specific surface area of a phase formed by the element C in the homogeneous silicon carbide material ranges from 900 m²/g to 1500 m²/g.

5. The homogeneous silicon carbide material according to claim 1, wherein a mass percentage of the element C in the homogeneous silicon carbide material ranges from 30 wt % to 70 wt %.

6. The homogeneous silicon carbide material according to claim 1, wherein a porosity of a phase formed by the element C in the homogeneous silicon carbide material ranges from 0.4 cc/g to 1.1 cc/g.

7. The homogeneous silicon carbide material according to claim 1, wherein a phase formed by the element C in the homogeneous silicon carbide material is a porous structure, and the porous structure is a mixed structure of a mesopore and a micropore; and/or
a pore diameter of the mesopore ranges from 4 nm to 14 nm, and a mesopore porosity of a phase formed by the element C in the homogeneous silicon carbide material ranges from 0.1 cc/g to 0.4 cc/g; and/or
a pore diameter of the micropore is in a range less than or equal to 1 nm, and a micropore porosity of a phase formed by the element C in the homogeneous silicon carbide material ranges from 0.3 cc/g to 0.9 cc/g.

8. The homogeneous silicon carbide material according to claim 1, wherein a median particle size Dᵥ₅₀ of the homogeneous silicon carbide material ranges from 5 μm to 15 μm; and/or
a specific surface area of the homogeneous silicon carbide material ranges from 3 m²/g to 10 m²/g.

9. The homogeneous silicon carbide material according to claim 1, wherein an element Li is introduced into the homogeneous silicon carbide material to form a material LiSi—C, and the material LiSi—C has a continuous phase structure in which a LiSi phase and a C phase are uniformly doped; and characteristic peaks exist in an X-ray diffraction pattern of the material LiSi—C, and the characteristic peaks occur when 2θ is in a range from 23° to 24° and is in a range from 41° to 42°.

10. The homogeneous silicon carbide material according to claim 9, wherein in the X-ray diffraction pattern of the material LiSi—C, a maximum intensity of a characteristic peak occurs when 2θ is in a range from 23° to 24° is I₃, and a maximum intensity of a characteristic peak occurs when 2θ is in a range from 41° to 42° is I₄, wherein I₃>I₄.

11. The homogeneous silicon carbide material according to claim 9, wherein in a scanning electron microscopy (SEM) cross-sectional view of the material LiSi—C, an internal structure of particles is a homogeneous structure at 50K magnification; and/or
a specific surface area of the C phase in the material LiSi—C ranges from 700 m²/g to 1500 m²/g.

12. The homogeneous silicon carbide material according to claim 9, wherein the material LiSi—C is in a form of particles, and a median particle size Dᵥ₅₀ ranges from 5 μm to 15 μm; and/or
a specific surface area of the material LiSi—C ranges from 3 m²/g to 10 m²/g.

13. The homogeneous silicon carbide material according to claim 9, wherein using a total weight of the material LiSi—C as a reference, in the material LiSi—C, a content of the element C ranges from 30 wt % to 70 wt %, a content of the element Li ranges from 0.2 wt % to 5 wt %, and a content of the element Si ranges from 29.8 wt % to 65 wt %.

14. The homogeneous silicon carbide material according to claim 9, wherein the material LiSi—C is used as a core to form a coated material LiSi—C with a core-shell structure; and/or
the coated material LiSi—C is in a form of particles, and a median particle size Dᵥ₅₀ ranges from 5 μm to 15 μm; and/or
a specific surface area of the coated material LiSi—C ranges from 1 m²/g to 5 m²/g.

15. The homogeneous silicon carbide material according to claim 14, wherein a shell of the coated material LiSi—C is an oxygen-containing coating layer; and/or
at a position where a surface depth of the oxygen-containing coating layer of the coated material LiSi—C is less than 10 nm, a content of an element O is O₁ %; and at a position where a depth is greater than 100 nm, a content of the element O is O₂ %, wherein O₁ %≥35% and O₁ %-O₂ %≥20%.

16. An electrode plate, wherein the electrode plate comprises a negative electrode current collector and a negative electrode active material layer coated on at least one side surface of the negative electrode current collector, the negative electrode active material layer comprises a negative electrode active material, and the negative electrode active material comprises graphite and the homogeneous silicon carbide material according to claim 1.

17. The electrode plate according to claim 16, wherein the graphite is artificial graphite or natural graphite; and/or
a median particle size Dᵥ₅₀ of the graphite ranges from 5 μm to 20 μm.

18. The electrode plate according to claim 16, wherein using a total weight of the negative electrode active material as a reference, a weight percentage of the graphite ranges from 45 wt % to 99 wt %, and a weight percentage of the homogeneous silicon carbide material ranges from 1 wt % to 55 wt %.

19. The electrode plate according to claim 16, wherein the negative electrode active material layer comprises a negative electrode conductive agent and a negative electrode binder; and using a total weight of the negative electrode active material layer as a reference, a weight percentage of the negative electrode active material ranges from 80 wt % to 99.8 wt %, a weight percentage of the negative electrode binder ranges from 0.1 wt % to 10 wt %, and a weight percentage of the negative electrode conductive agent ranges from 0.1 wt % to 10 wt %.

20. A battery, wherein the battery comprises the electrode plate according to claim 16.
